(19) United States
(12) Patent Application Publication
(10) Pub. No.: US 2021/0001690 A1
(43) Pub. Date: Jan. 7, 2021

(54) EVAPORATOR, NOTABLY FOR A MOTOR VEHICLE AIR CONDITIONING CIRCUIT, AND CORRESPONDING AIR CONDITIONING CIRCUIT

(71) Applicant: Valeo Systemes Thermiques, Le Mesnil Saint Denis Cedex (FR)

(72) Inventors: Frédéric Tison, La Suze Sur Sarthe (FR); Sylvain Moreau, La Suze Sur Sarthe (FR); Aurélie Bellenfant, La Suze Sur Sarthe (FR); Lionel Robillon, La Suze Sur Sarthe (FR); Bastien Jovet, Le Mesnil Saint Denis Cedex (FR)

(73) Assignee: Valeo Systemes Thermiques, Le Mesnil Saint Denis Cedex (FR)

(21) Appl. No.: 16/496,631

(22) PCT Filed: Mar. 22, 2018
(86) PCT No.: PCT/FR2018/050704

§ 371 Date: Sep. 3, 2020

(30) Foreign Application Priority Data
Mar. 23, 2017 (FR) 1752411

(51) Int. Cl. B60H 1/32; F28F 3/08

(52) U.S. Cl. CPC B60H 1/3227; F28F 3/086

(57) ABSTRACT

The invention relates to an evaporator (111), notably for a motor vehicle air conditioning circuit (100), comprising a stack of plates forming tubes (300) for the circulation of a refrigerant fluid together delimiting air passages to cool an air flow (250) flowing through said passages through the evaporator (111).

According to the invention, at least one of said tubes (300) has a single flow path (315a, 315b, 315c) for said refrigerant fluid between an inlet orifice (310) and an outlet orifice (320), said flow path (315a, 315b, 315c) comprising a plurality of successive passes, said inlet orifice (310) of said at least one tube (300) being in fluid communication with a refrigerant fluid inlet port (210) of said evaporator (111), and said outlet orifice (320) of said at least one tube (300) being in fluid communication with a refrigerant fluid outlet port (220) of said evaporator (111).

### 1 TECHNICAL DOMAIN

The invention relates to evaporators, in particular evaporators that are used in the air conditioning circuits of motor vehicles.

### 2 TECHNOLOGICAL BACKGROUND

Air conditioning circuits that use a refrigerant fluid are known.

Such circuits typically include, in the direction of flow of the refrigerant fluid, a compressor, a condenser, an evaporator, an expansion valve and an accumulator.

It is also known to provide an internal heat exchanger inside the air conditioning circuit to improve the performance of the evaporator. An internal exchanger is a device enabling the refrigerant fluid to exchange heat with said refrigerant fluid in a different temperature and pressure state.

The high-pressure refrigerant fluid coming from the compressor is condensed in the condenser and then moves into a first portion of the internal exchanger. The refrigerant fluid is then expanded by the expansion valve. The low-pressure refrigerant fluid coming out of the expansion valve then moves through the evaporator to be evaporated, then through the accumulator and into a second portion of the internal heat exchanger, before returning to the compressor.

In the internal exchanger, the high-pressure hot fluid exchanges heat with the low-pressure cold fluid. In other words, the internal exchanger provides a heat exchange for the refrigerant fluid at two different points of the air conditioning circuit.

The evaporator enables the production of a cold or air-conditioned air flow that can be conveyed, for example, into the passenger compartment of a motor vehicle.

Conventionally, evaporators comprise on one side a core usually containing two layers of parallel ducts for refrigerant fluid flow, and on the other side means for distributing the refrigerant fluid that are arranged at the two ends of these layers to ensure the distribution and collection of the refrigerant fluid in the different ducts of each of the layers.

According to the terminology in the field, “layer” means a refrigerant fluid circuit arranged in a single plane orthogonal to the air flow to be cooled. The layers are conventionally made up of parallel ducts for the circulation of the refrigerant fluid.

According to a known solution, the ducts are made from pairs of plates arranged side by side to form a tube.

The pairs of plates or tubes can be arranged alternately with inserted disruptors across which an air flow can pass.

According to another known solution, the ducts are made from manifolds or multi-channel tubes.

In the case of plate evaporators, the ducts are distributed between different zones, in which each zone forms a flow pass for the refrigerant fluid. In other words, several ducts form one pass.

In the case of tube evaporators, these passes are defined by the internal partitions provided in the collector boxes.

The distribution means (arrangement of plates or internal partitioning of the collector boxes) are therefore designed to enable the refrigerant fluid to flow in several passes, with an inversion of the flow direction of the refrigerant fluid from one pass to the next.

Conventionally, each of the two layers of these evaporators has three or four passes.

An air flow crosses the gaps between the refrigerant fluid ducts and gives up heat to the refrigerant fluid changing from the liquid state to the gas state.

The air flow thus cooled can in particular be used subsequently to air condition the passenger compartment of a motor vehicle.

Two-layer evaporators with several different fluid paths that define, within the portions of each layer and/or from one layer to the other, a fluid path that forms U-shaped circuits and/or that has crossed flows (i.e. opposite directions) are well known to the person skilled in the art and widely described in the prior art.

Operation of these evaporators is satisfactory, but the heat exchange between the refrigerant fluid and the air to be cooled needs to be improved.

This involves improving the uniformity of the temperature of the refrigerant fluid between the different regions (right/left, top/bottom) of the evaporator to improve the distribution of the pressure drops within the different regions of the evaporator.

There is therefore a need for an evaporator with improved heat exchange performance compared to the known devices.

### 3 SUMMARY

The present invention is intended to overcome these problems in the prior art by proposing an evaporator, notably for a motor vehicle air conditioning circuit, comprising a stack of plates forming tubes for the circulation of a refrigerant fluid together delimiting air passages to cool an air flow flowing through said passages through the evaporator.

According to the invention, at least one of said tubes has a single flow path for said refrigerant fluid between an inlet orifice and an outlet orifice, said flow path comprising a plurality of successive passes, said inlet orifice of said at least one tube being in fluid communication with a refrigerant fluid inlet port of said evaporator, and said outlet orifice of said at least one tube being in fluid communication with a refrigerant fluid outlet port of said evaporator.

Thus, the invention proposes a novel and inventive solution to improve the performance of an evaporator, for example an evaporator used in an air conditioning circuit of a motor vehicle.

To do so, the invention proposes using a stack of tubes, in which each tube has a single flow path for the refrigerant fluid grouping together all of the flow passes required of the refrigerant fluid, said passes being in this case arranged in series in a given tube.

Thus, by feeding all of the tubes in question in parallel, the phenomena of remixing (or redistribution) conventionally found in the collectors in evaporators in the prior art when a refrigerant fluid moves from one pass to the other via such a collector are in this case reduced (a portion of liquid coming out of one pass does not have the option of several manifolds for the following pass).

Accordingly, the corresponding pressure drops in the collectors are in this case switched back to the tubes according to the invention.

The flow rate of the refrigerant fluid in the different tubes making up the evaporator is thus more uniform, thereby improving the overall performance of the evaporator.

According to a particular aspect of the invention, said flow path of at least one of said tubes has four flow passes for said refrigerant fluid.

According to a particular aspect of the invention, said at least one tube has three plates together delimiting said flow path of said refrigerant fluid, said flow path including a first U-shaped flow in a direction orthogonal to said air flow to be cooled, said first flow being followed by a second U-shaped flow in a direction parallel to said air flow to be cooled, the second flow being itself followed by a third U-shaped flow in a direction orthogonal to said air flow to be cooled and opposite the direction of said first flow.

Thus, alternating the directions of flow of the refrigerant fluid in adjacent passes (both in a given tube and in the successive tubes of the stack) improves the uniformity of the temperature at the heat-exchange surfaces with the air flow.

According to a particular aspect of the invention, at least one of said three plates is a stamped plate that has at least one duct and that is designed to cooperate with at least one face of another of said three plates such as to form at least one portion of said flow path of said refrigerant fluid.

This makes the tubes simple and economical to manufacture.

According to a particular aspect of the invention, one of said three plates is a corrugated central plate arranged between two other plates of said three plates.

Thus, the calorie exchange is improved between the different flow passes of the refrigerant fluid in the tube in question.

According to a particular aspect of the invention, said three plates are designed to delimit a refrigerant fluid feed section, a refrigerant fluid feed path resulting from the cooperation of feed sections obtained for each tube of said stack, said feed path bringing the inlet orifices of said tubes of said stack into fluid communication with said refrigerant fluid inlet port of said evaporator, and bringing the outlet orifices of said tubes of said stack into fluid communication with said refrigerant fluid outlet port of said evaporator.

Thus, the fluid communication joint between the inlets and the outlets of the tubes is simple and economical. According to a particular aspect of the invention, the tubes of said stack are stacked alternately with inserted fins traversed by said air flow to be cooled.

Thus, the exchange of calories between the refrigerant fluid and the air flow is improved.

According to a particular aspect of the invention, the evaporator has a depth of 38 mm.

Thus, the evaporator can easily be built into a standard heating, ventilation and air-conditioning (HVAC) casing.

The invention also relates to an air conditioning circuit including an evaporator as described above.

### 4 LIST OF FIGURES

Other features and advantages of the invention will become apparent on reading the description below, given by way of non-limiting example, and the attached drawings, in which:

FIG. 1 is a diagram showing an air conditioning circuit in which an evaporator according to the invention can be installed,

FIG. 2 shows a plate evaporator as well as a known example of refrigerant fluid flow inside said evaporator,

FIG. 3 is a schematic view of elements making up a tube stack intended for an evaporator according to one embodiment of the described art,

FIG. 4 is a schematic view of a refrigerant fluid feed path of a tube stack intended for an evaporator according to one embodiment of the described art.

### 5 DETAILED DESCRIPTION OF THE INVENTION

In all of the figures of the present document, identical elements are indicated using the same reference sign.

The general principle of the invention involves a plate evaporator including a stack of flat tubes that together delimit air passages used to cool an air flow passing through said passages.

At least one tube in the stack, which is formed by plates arranged side by side, has a single flow path for the refrigerant fluid between an inlet orifice and an outlet orifice, the path comprising a plurality of successive passes arranged in series.

Furthermore, the inlet orifice of the tube is in fluid communication with the fluid inlet port of the evaporator, and the outlet orifice of the tube is in fluid communication with the fluid outlet port of the evaporator.

Thus, all of the flow passes through which a given fraction of the refrigerant fluid must pass are in this case arranged in series in a given tube.

The different tubes of the stack are furthermore fed in parallel.

More specifically, the inlet orifice of each tube in the stack is in fluid communication with the fluid inlet port of the evaporator, and the outlet orifice of each tube in the stack is in fluid communication with the fluid outlet port of the evaporator.

The phenomena of remixing found in the collectors in the evaporators in the prior art are in this case reduced (according to the described art, a portion of the fluid coming out of a pass no longer has a choice between several passages for the following pass).

The corresponding pressure drops are then switched back to the tubes.

The flow rate of the refrigerant fluid in the different tubes making up the evaporator is thus more uniform, thereby improving the overall performance of the evaporator.

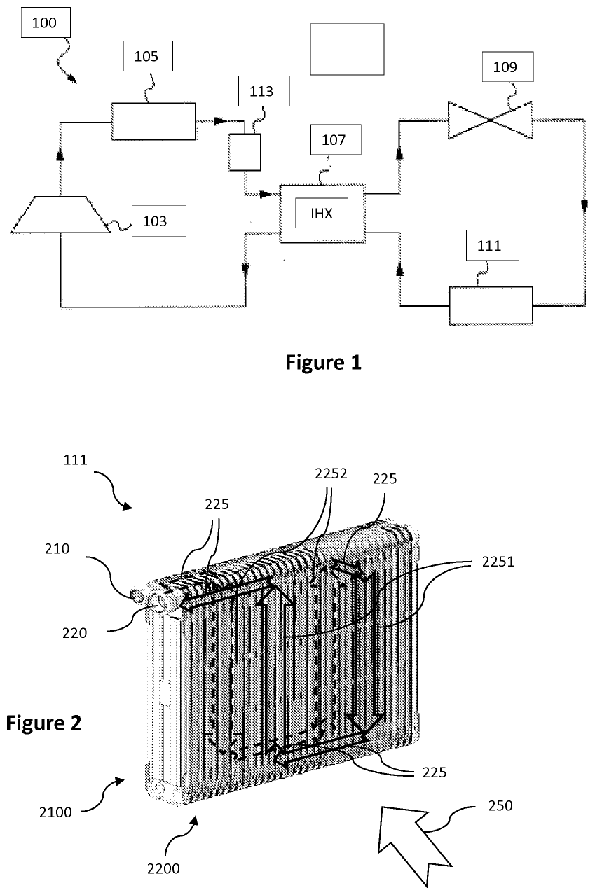

The elements that make up a conventional air conditioning circuit 100, in which an evaporator according to the invention can be installed, are described below with reference to FIG. 1.

The air conditioning circuit 100 includes a compressor 103, a condenser 105, an internal heat exchanger 107, an expansion valve 109, an evaporator 111 and a dryer 113, these different elements being linked to one another by joining parts such as manifolds, hoses or the like, in order to ensure a refrigerant fluid flow.

The refrigerant fluid is typically a chlorinated fluorinated liquid operating in a subcritical regime, such as the R-134a liquid, a mixture of HFO-1234yf and CF31, or any other refrigerant fluid capable of operating in a subcritical regime.

The arrows in FIG. 1 indicate the flow of the refrigerant fluid. The refrigerant fluid, conveyed by the compressor 103, passes through the condenser 105, from which the refrigerant fluid comes out in a high-pressure, high-temperature state. The refrigerant fluid then passes through the internal heat exchanger 107 via an internal flow circuit, referred to as the high-pressure circuit, before being expanded in the expansion valve 109. The fluid thus expanded is then conveyed towards the evaporator 111 before returning to the internal heat exchanger 107 in a low-pressure, low-temperature state, passing through said heat exchanger via an internal flow circuit, referred to as the high-pressure circuit. The dryer 113 is inserted between the condenser 105 and the internal heat exchanger 107.

In the internal heat exchanger 107, the low-pressure refrigerant fluid coming from the evaporator 111 exchanges heat with said high-pressure refrigerant fluid coming from the condenser 105.

At the outlet of the internal heat exchanger 107, the liquid returns to the compressor 103, and so forth.

The structure of a plate evaporator 111 and a known example of four-pass circulation of refrigerant fluid inside the evaporator 111 are described below with reference to FIG. 2.

The evaporator 111 has an evaporator core comprising two adjacent layers 2100, 2200 lying in parallel planes.

Each layer is formed by a plurality of parallel ducts made from pairs of plates arranged side by side to form a tube. A refrigerant fluid passes through such a tube to cool the air flow 250 passing through the first and second layers 2100, 2200 successively.

In a known manner, the plates are designed to form liquid distribution means at the two ends (upper and lower) of the layers 2100, 2200, in which said means distribute and collect the refrigerant fluid in the different ducts of the layers 2100, 2200, creating a fluid flow in a given direction for each duct between the distribution means.

The evaporator 111 has a fluid inlet port 210 to convey the refrigerant fluid from the outside of the evaporator 111 (for example from the expansion valve 109) to the core of the evaporator 111.

Equally, a fluid outlet port 220 is used to convey the refrigerant fluid from the core of the evaporator 111 to the outside of the evaporator 111 (for example to the internal heat exchanger 107).

The plates have orifices at the upper end, said orifices having peripheral flanges intended to form an inlet collection space linked to the fluid inlet 210 and an outlet collection space linked to the fluid outlet 220 when the plates are stacked.

According to the known arrangement shown, the refrigerant fluid follows a path inside the core of the evaporator 111 comprising two passes per layer (shown here using the arrows 2251 for the first layer 2200, i.e. the layer arranged on the side of the incoming air flow 250 to be cooled, and by the arrows 2252 for the second layer 2100 positioned on the side of the cooled air flow).

In practice, several parallel ducts form the same number of possible passages in a pass for the refrigerant fluid (i.e. one of the arrows 2251 or 2252 representing one pass is formed by several parallel ducts).

Conventionally, the refrigerant fluid moves from one pass to the other via a collector box enabling the refrigerant fluid to move from the ducts of one pass to the ducts of another pass (move represented here by the arrows 225).

However, according to this known arrangement, all of the ducts are arranged in parallel for a given pass leading to the same collector box in order to feed the plurality of parallel ducts of the following pass.

This necessarily results in pressure drops when remixing the refrigerant fluid in the collector box (i.e. a fraction of refrigerant fluid coming out of a given duct of an upstream pass could flow into any one of the ducts of the following pass. Since this is true for all of the fractions of refrigerant fluid coming out of the different ducts of the upstream pass in question, remixing occurs in the collector box before the different fractions of refrigerant fluid enter the plurality of parallel ducts of the following pass).

An evaporator according to the invention has the same structure as described in relation to FIG. 2.

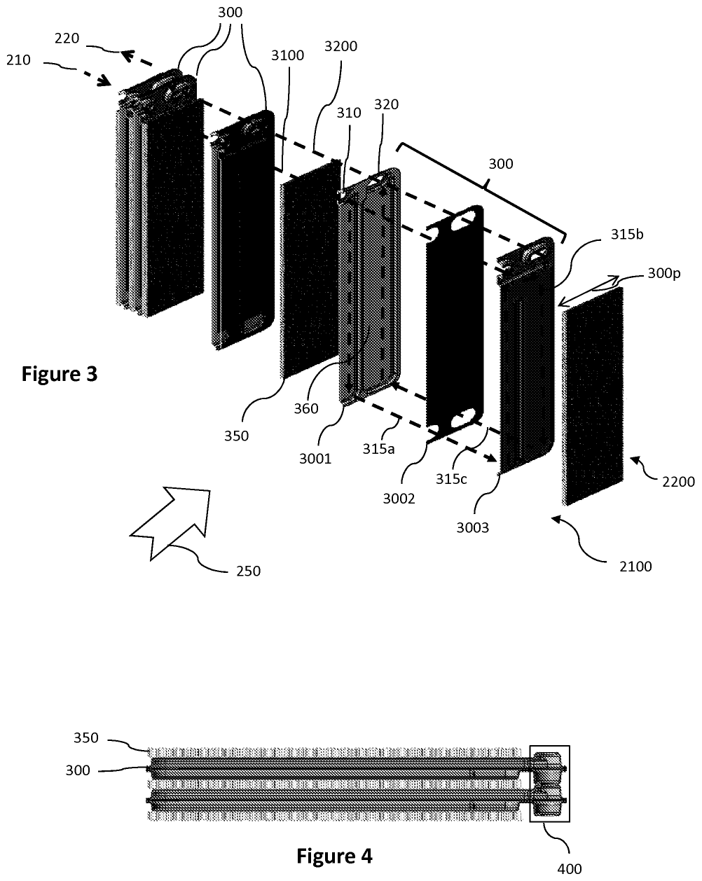

FIG. 3 shows a portion of an evaporator according to the invention. Said evaporator comprises a stack of plates forming flat tubes 300 together delimiting air passages designed to cool the air flow 250 flowing through the passages in question.

According to this embodiment, a tube 300 of the stack has three plates 3001, 3002, 3003 (for example made of aluminum) together delimiting a single flow path for the refrigerant fluid between the inlet orifice 310 of the tube 300 and the outlet orifice 320 of the tube 300, in which the path comprises a plurality of successive passes arranged in series.

The inlet orifice 310 and the outlet orifice 320 of the tube 300 are positioned at the same upper end of the tube 300. The plates 3001, 3002, 3003 have two holes in the upper end thereof, and only the inserted/central plate 3002 has two holes in the lower end thereof.

Furthermore, the inlet orifice 310 of the tube 300 is in fluid communication with the fluid inlet port 210 of the evaporator via a fluid flow path indicated by the dotted-line arrows 3100. Equally, the outlet orifice 320 of the tube 300 is in fluid communication with the fluid outlet port 220 of the evaporator via a fluid flow path indicated by the dotted-line arrows 3200.

Thus, all of the flow passes through which the refrigerant fluid must pass are in this case arranged successively in series in a given tube 300.

A plurality of such tubes 300 is then fed in parallel from the fluid inlet port 210 of the evaporator 111 to the inlet orifices 310 of the tubes in question via the fluid flow path represented by the dotted-line arrows 3100. The outlet orifices 320 of said tubes are all connected fluidically with the fluid outlet port 220 of the evaporator 111 via the fluid flow path indicated by the dotted-line arrows 3200.

The remixing (or redistribution) phenomena found with the collectors used in the known solutions described above are in this case reduced.

The corresponding pressure drops are thus switched back to the tubes 300 as a result of the invention.

The flow rate of the refrigerant fluid in the different tubes 300 making up the evaporator 111 is thus more uniform, thereby improving the overall performance of the evaporator 111.

The plates form a tube that define a flow path of the refrigerant fluid that includes four passes, in which each pass is defined by a fluid flow duct (in this case, “pass” shall mean the route of the refrigerant fluid in a duct of a layer 2100, 2200).

More specifically, the flow path of the refrigerant fluid includes a first U-shaped flow (dotted-line arrows 315a) in a direction orthogonal to the air flow 250. The first U-shaped flow is then followed by a second U-shaped flow (dotted-line arrows 315b) in a direction parallel to the air flow 250, the second flow being itself followed by a third U-shaped flow (dotted-line arrows 315c) in a direction orthogonal to the air flow 250 and opposite the direction of the first U-shaped flow.

Consequently, the flow path for each tube has four flow passes for the refrigerant fluid, in which two of said passes belong to the first layer 2100 and the other two of the four passes belong to the second layer 2200. Consequently, a single tube contains two layers and four passes.

An evaporator 111 referred to as a “four-pass two-layer evaporator” is thus obtained by a stack of such tubes 300 according to the described art.

Furthermore, the direction of flow of the refrigerant fluid in adjacent passes (both in a given tube 300 and in successive tubes 300 in the stack) is alternated. The temperature of the tube is also averaged by conduction between the plates. The temperature uniformity is thereby improved on the heat-exchange surfaces with the air flow 250.

In a variant, at least one of the three plates 3001, 3002, 3003 is a stamped plate with at least one duct 360.

Furthermore, the plate in question is designed to cooperate with at least one face of another of the three plates 3001, 3002, 3003 to form at least one portion of the flow path of the refrigerant fluid.

This makes the tubes simple and economical to manufacture.

In a variant, the central plate 3002 that is arranged between two other plates 3001, 3003 of the three plates 3001, 3002, 3003 forming the tube 300 is a corrugated central plate.

Thus, the calorie exchange is improved between the different flow passes of the refrigerant fluid in the tube 300 in question.

In the embodiment illustrated in FIG. 3, the tubes 300 of the stack are stacked alternately with inserted fins 350 traversed by the air flow 250.

Thus, the heat exchange between the refrigerant fluid and the air flow is improved.

Furthermore, the fluid communication between the fluid inlet port 210 of the evaporator 111 and the inlet orifices 310 of the tubes 300 of the stack, as well as the fluid communication between the fluid outlet port 220 of the evaporator 111 and the outlet orifices 320 of said tubes 300 occurs on the same side of the tubes 300 (in this case the upper portion). Consequently, the other side of the tubes 300 (in this case on the lower portion) is left free.

The fins 350 can thus be arranged up to the end of the portion left free (in this case therefore up to the end of the lower portion) of the tubes 300, thereby enabling the heat exchange between the refrigerant fluid and the incident air flow 250 to be improved.

In the embodiment illustrated in FIG. 3, the tubes 300 used are all identical.

Thus, the evaporator 111 is obtained in a modular manner and different lengths can be applied as a function of the number of tubes 300 stacked.

Consequently, several ranges of evaporators can be covered using the same basic tubes 300, thereby simplifying the industrial manufacturing process of such evaporators 111.

A refrigerant fluid feed path 400 of a stack of tubes 300 intended for an evaporator 111 according to one embodiment of the described art is described below with reference to FIG. 4.

According to this embodiment, the three plates 3001, 3002, 3003 forming the tube 300 are designed to delimit a refrigerant fluid feed section of the tube 300, for example via cylindrical sections extending perpendicularly to the plane of the outer plates 3001, 3003 from the inlet 310 and outlet 320 of the tube 300.

Consequently, a refrigerant fluid feed path 400 is obtained via the cooperation (for example by stamping, crimping, brazing, etc.) of the feed sections of each tube 300 of the stack during assembly of the tubes 300 with one another to form the stack in question.

More specifically, the feed path 400 thus obtained brings the inlet orifices 310 of the tubes of the stack into fluid communication with the fluid inlet 210 of the evaporator, and the outlet orifices 320 of the tubes of the stack into fluid communication with the fluid outlet 220 of the evaporator.

Thus, the fluid communication joint between the inlets and the outlets of the tubes 300 is simple and economical.

In one embodiment, the evaporator 111 has a depth 300p of 38 mm in a direction perpendicular to the stacking direction of the tubes 300.

This enables such an evaporator exchanger 111 to be built into a standard HVAC casing without having to substantially modify the latter.

The use of an evaporator 111 according to the described art in an air conditioning circuit 100 built into a motor vehicle helps to improve the air conditioning and therefore comfort inside the passenger compartment of the vehicle.

1. An evaporator for a motor vehicle air conditioning circuit, comprising:
a stack of plates forming tubes for the circulation of a refrigerant fluid together delimiting air passages to cool an air flow flowing through said passages through the evaporator,
wherein at least one of said tubes forms a single flow path for said refrigerant fluid between an inlet orifice and an outlet orifice,
said flow path comprising a plurality of successive passes,
said inlet orifice of said at least one tube being in fluid communication with a refrigerant fluid inlet port of said evaporator, and
said outlet orifice of said at least one tube being in fluid communication with a refrigerant fluid outlet port of said evaporator.

2. The evaporator as claimed in claim 1, wherein said flow path of at least one of said tubes has four flow passes for said refrigerant fluid.

3. The evaporator as claimed in claim 2, wherein said at least one tube has three plates that together delimit said flow path of said refrigerant fluid, said flow path including a first U-shaped flow in a direction orthogonal to said air flow to be cooled, said first flow being followed by a second U-shaped flow in a direction parallel to said air flow to be cooled, the second flow being itself followed by a third U-shaped flow in a direction orthogonal to said air flow to be cooled and opposite the direction of said first flow.

4. The evaporator as claimed in claim 3, wherein at least one of said three plates is a stamped plate that has at least one duct and that is configured to cooperate with at least one face of another of said three plates to form at least one portion of said flow path of said refrigerant fluid.

5. The evaporator as claimed in claim 3, wherein one of said three plates is a corrugated central plate arranged between two other plates of said three plates.

6. The evaporator as claimed in claim 3, wherein said three plates are configured to delimit a refrigerant fluid feed section, a refrigerant fluid feed path resulting from the cooperation of feed sections obtained for each tube of said stack, said feed path bringing the inlet orifices of said tubes of said stack into fluid communication with said refrigerant fluid inlet port of said evaporator, and bringing the outlet orifices of said tubes of said stack into fluid communication with said refrigerant fluid outlet port of said evaporator.

7. The evaporator as claimed in claim 1, wherein the tubes of said stack are stacked alternately with inserted fins traversed by said air flow to be cooled.

8. The evaporator as claimed in claim 1, wherein the evaporator has a depth of 38 mm.

9. An air conditioning circuit, comprising:
an evaporator comprising a stack of plates forming tubes for the circulation of a refrigerant fluid together delimiting air passages to cool an air flow flowing through said passages through the evaporator,
wherein at least one of said tubes forms a single flow path for said refrigerant fluid between an inlet orifice and an outlet orifice,
said flow path comprising a plurality of successive passes,
said inlet orifice of said at least one tube being in fluid communication with a refrigerant fluid inlet port of said evaporator, and
said outlet orifice of said at least one tube being in fluid communication with a refrigerant fluid outlet port of said evaporator.

10. An evaporator for a motor vehicle air conditioning unit, comprising:
a stack of plates forming tubes for the circulation of a refrigerant fluid together delimiting air passages to cool an air flow flowing through said passages through the evaporator, each tube having a single flow path for the refrigerant fluid,
said flow path comprising a plurality of successive passes, said passes being arranged in series in a corresponding tube such that a flow rate of the refrigerant fluid in the tubes is substantially uniform,
an inlet orifice of at least one tube being in fluid communication with a refrigerant fluid inlet port of said evaporator, and
an outlet orifice of said at least one tube being in fluid communication with a refrigerant fluid outlet port of said evaporator.
